(19) United States
(12) Patent Application Publication
(10) Pub. No.: US 2019/0389713 A1
(43) Pub. Date: Dec. 26, 2019

(54) APPARATUS FOR DISPENSING A HEATED LIQUID FOODSTUFF

(71) Applicant: Friedhelm Selbach GmbH, Radevormwald (DE)

(72) Inventor: Torsten SELBACH, Radevormwald (DE)

(73) Assignee: Friedhelm Selbach GmbH, Radevormwald (DE)

(21) Appl. No.: 16/449,551

(22) Filed: Jun. 24, 2019

(30) Foreign Application Priority Data
Jun. 26, 2018 (DE) 10 2018 115 357.0

(51) Int. Cl. B67D 1/08; B67D 1/14

(52) U.S. Cl. CPC B67D 1/0895; B67D 2001/0093; B67D 1/14

(57) ABSTRACT

An apparatus for dispensing a heated liquid foodstuff, in particular a hot drink, such as preferably coffee, has a heating device for the liquid foodstuff and a dispensing nozzle. The liquid foodstuff is dischargeable from a pressurised receptacle and a pressure reducing device is arranged before the heating device.

### CROSS-REFERENCE TO RELATED APPLICATIONS

This application claims priority under 35 USC 119 of German Application No. 10 2018 115 357.0, filed on Jun. 26, 2018, the disclosure of which is herein incorporated by reference.

### TECHNICAL FIELD

The invention relates to an apparatus for dispensing heated liquid foodstuffs, in particular a hot drink, such as preferably coffee, with a heating device for the liquid foodstuff and a dispensing nozzle.

### STATE OF THE ART

Such an apparatus is known for example from German Application No. DE 10046558 A1. A liquid foodstuff is delivered as needed from a storage reservoir by means of a pump provided in the apparatus, which liquid foodstuff is heated by a heating device in the form of a heat exchanger before its removal via a dispensing nozzle.

### SUMMARY OF THE INVENTION

In view of the state of the art described above, it is an object of the invention to further improve an apparatus of the kind under discussion in advantageous manner.

This object is accomplished by a dispenser for liquid foodstuff in which the liquid foodstuff is dischargeable from a receptacle under pressure and a pressure reducing device is arranged before the heating device.

The liquid foodstuff is preferably discharged from a beverage container which is subjected to a positive pressure of for example 2 bar up to for example 3 bar. Alternatively, a pump with a maximum discharge or cutoff pressure of up to about 3 bar may also be provided, preferably outside of the apparatus. In order to reduce the fluid pressure acting in delivery direction before the heating device and therewith also before the dispensing nozzle, a pressure reducing device is provided before the heating device when considered in the delivery direction. Via this, a reduction of the fluid pressure may be induced, for example to a delivery and/or cutoff pressure usual for dispensing apparatuses of about 1 to 2 bar, more preferably about 1.5 bar.

Accordingly, the heating device is provided between the pressure reducing device and the dispensing nozzle when considered in delivery direction of the liquid foodstuff.

Further features of the invention are explained in the following text, also in the description of figures. But they may also be of significance in an assignment to only individual features of variants of the invention.

Accordingly, the pressure reducing device may consist of a pressure reducing valve integrated in a feed line for the liquid foodstuff. In this context, the feed line may be part of the pressure reducing device at least in a portion thereof.

The pressure reducing valve may also be embodied as a plunger with a conical end facing against the delivery direction, which is inserted in a correspondingly conically formed section of the feed line. In this way, a compensator for the pressure reduction is created. This may be designed, as also preferably, in the form of an inline compensator. Within the compensator, a reduction of the flow rate per unit of time is achieved, wherein the liquid foodstuff flows around the plunger and permeates an annular space created between the plunger outer surface and facing, enclosing inner surface of the feed line.

In order to adjust the pressure reduction, correspondingly to adjust the reduced, outlet-side fluid pressure, the plunger may be displaceable relative to the feed line in the longitudinal direction of the feed line, more preferably in and counter to the delivery direction of the liquid foodstuff. Such an adjustment may be carried out, as preferably, from the outside. Thus additionally, such an adjustment may also be made while liquid foodstuff is propelled through the compensator.

In one possible variant, the heating device consists of a section of the feed line which is acted upon by means of a thermal conductor. The transfer of heat to the liquid foodstuff may take place as a consequence of a heated solid material in which the thermal conductor may be embedded. In preferred variant, the heatable solid material completely surrounds the feed line in the heating device section in question to achieve preferably even heat transfer. In this context, the solid material serves as heat exchanger, for which purpose the solid material is equipped with a thermal conductor.

The thermal conductor embedded in the solid material may be a liquid line.

In addition, according to a preferred variant the delivery line may be a steel pipe, in particular a stainless steel pipe, which passes through the solid material in the region of the heating device. In such context, the solid material may consist of aluminium. Here it may be advisable to heat the solid material up by means of a resistance heater.

Correspondingly, according to a preferred variant an electrically powered heating device may be provided.

The stainless steel pipe forming the feed line may be cast in an aluminium block together with up to three heating elements of a resistance heater, whereby a very favourable heat transfer may be achieved. The thermal energy which is supplied to the aluminium solid material by the heating elements of the resistance heater is transferred to the liquid foodstuff flowing through the stainless steel pipes indirectly due to the good thermal conductivity of the aluminium.

According to a preferred variant, the apparatus may essentially have a front face with the dispensing nozzle and two oppositely positioned side walls optionally extending substantially vertically in the operating state, and a rear wall. The apparatus may further have a bottom and a top cover. Accordingly in this way an overall cuboid shape of the apparatus may be created. An overall circular cylindrical or barrel-like shape of the apparatus may also be created, wherein the front face and optionally the rear wall may be constructed in the form of circular discs.

In a preferred variant, the pressure reduction device and the heating device are arranged inside the apparatus, while the receptacle under pressure is provided outside the apparatus. The pressure reducing device and heating device are thus part of the apparatus, whereas the pressurised receptacle or a receptacle with a connected external pump for generating the pressure may optionally be connected to the apparatus.

In a further possible variant, the pressure reducing device may be accessible from a side wall of the apparatus. To this end, the side wall as a whole or a partial area thereof may be pivotable downwards or upwards, also optionally completely removable. The pressure reducing device is accessible through the opening created thereafter, for example for cleaning or replacement purposes, also optionally for adjusting the pressure reduction.

### BRIEF DESCRIPTION OF THE DRAWINGS

In the following text, the invention will be explained in greater detail with reference to the accompanying drawing, which represents only a single embodiment. In the drawings:

FIG. 1 is a perspective, schematic representation of an apparatus for dispensing a heated liquid foodstuff with an attached receptacle for the liquid foodstuff;

FIG. 2 is a schematic representation of a cross-section through the apparatus with the apparatus housing replicated by a dot-dashed line style;

FIG. 3 shows a pressure reducing device of the apparatus in perspective representation;

FIG. 4 shows the pressure reducing device in detail view;

FIG. 5 shows the section through the pressure reducing device along line V-V in FIG. 4.

### DESCRIPTION OF THE EMBODIMENTS

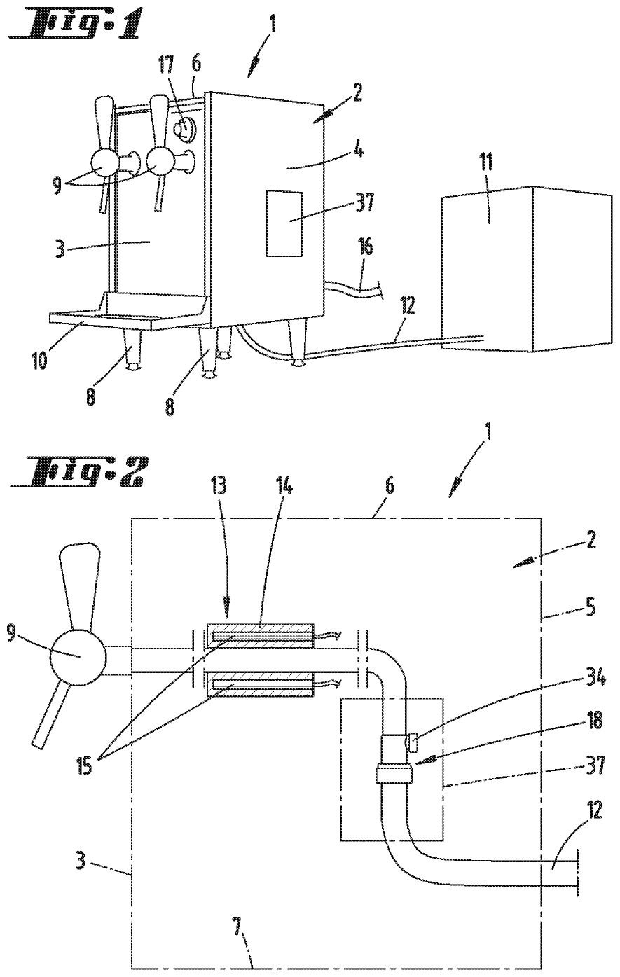

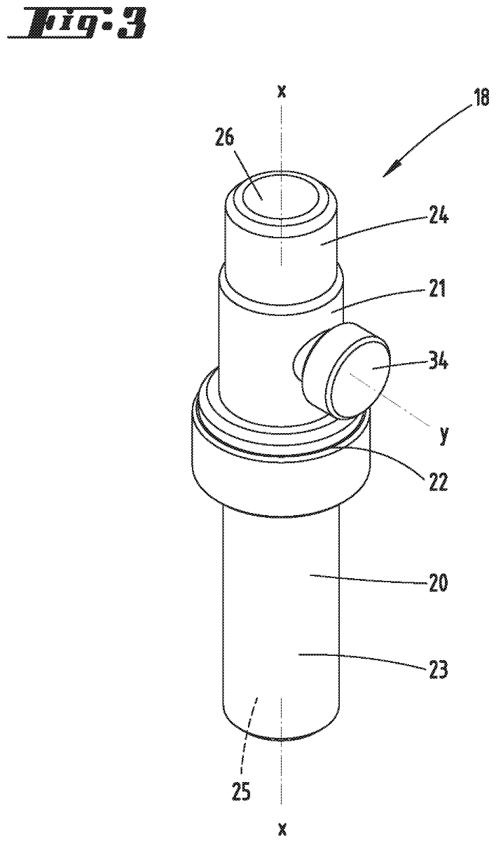

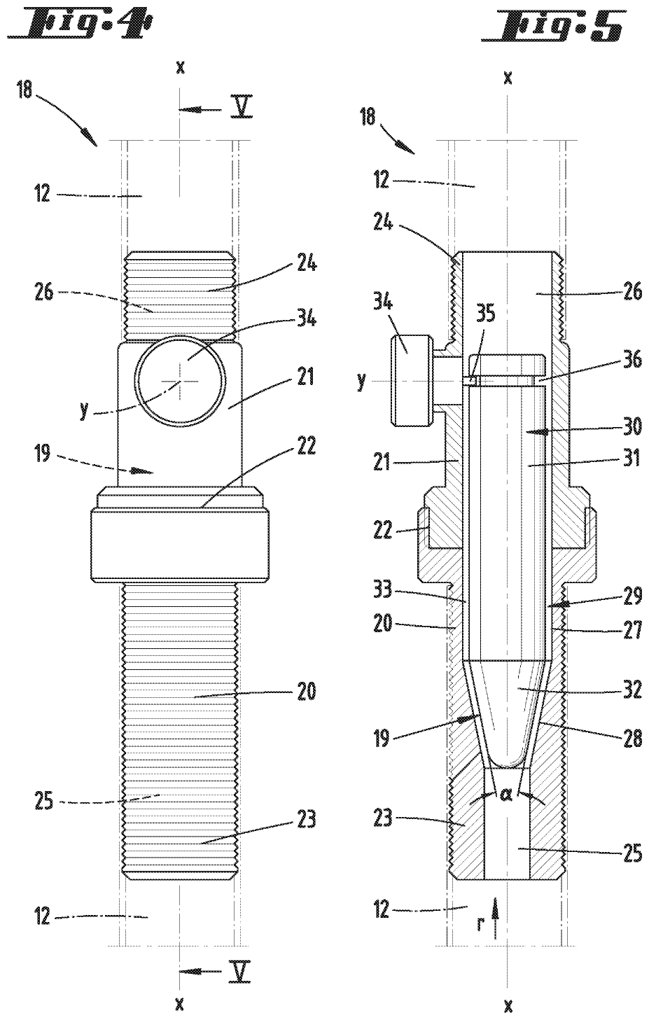

An apparatus 1 for dispensing a heated liquid foodstuff is represented and described, firstly with reference to FIG. 1. Such a foodstuff here may as also preferably be a hot drink, further for example such as coffee.

The apparatus has a housing 2 with a front face 3, in the embodiment shown two oppositely positioned side walls 4 extending substantially vertically in the operating state, and a rear wall 5. On the upper side, the housing 2 is covered by a top face 6. Below, the housing 2 is delimited by a bottom 7.

The apparatus 1 supports itself on a work surface by means of adjustable feet 8 arranged underneath the bottom 7.

At least one dispensing nozzle 9 is arranged in the area of the front face 3. In the embodiment represented, two dispensing nozzle 9 are provided for dispensing two possibly different beverages, in particular hot drinks. However, it is also possible for example that one hot drink and one cold drink may be dispensed via the two dispensing nozzles 9.

A drip tray 10 is provided at the front and attached to the bottom 7 with vertical separation from the dispensing nozzles 9.

The apparatus 1 serves for dispensing a liquid which is stored in a receptacle 11 that is arranged outside the housing 2.

The receptacle 11 may be pressurised, as is preferred, so that for example a discharge pressure of about 2.5 to 3 bar results. This pressure may also be generated by an external pump in the case of an unpressurised receptacle.

The liquid foodstuff is passed through a feed line 12 provided between receptacle 11 and apparatus 1, wherein the section of the feed line 12 between receptacle 11 and apparatus 1 is preferably a tube line.

A tube line may also be provided substantially inside the apparatus 1 to fulfil the function of the feed line 12, wherein the feed line 12 inside the apparatus 1 substantially constitutes the line connection to the assigned dispensing nozzle 9.

An electrically powered heating device 13 is provided in the apparatus 1. This heating device 13 firstly consists substantially of a block of a solid material 14, consisting particularly of aluminium which encloses the feed line 12. In one possible variant, the section of the feed line 12 which passes through this solid material 14 is in the form of a stainless steel pipe. The outer wall of the feed line in this section is preferably in full surface contact with the facing hole wall of the solid material 14.

Electric heating elements 15 are embedded in the solid material 14. Here, the arrangement of a plurality of heating elements 15, for example two, three or for heating elements, is preferred.

The heating element 15 and the section of the feed line 12 which passes through the solid material may be cast in the solid material 14, as is also preferred.

For the electrical supply to the heating elements 15, the apparatus 1 is provided with an electrical connection 16, represented schematically in FIG. 1.

The heat output of the heating element 15 may optionally be controllable. For this purpose, a temperature regulator 17 may be provided in the area of the front face 3 and may also have a switching function for starting and switching off the heating element 15.

In order to reduce the fluid pressure, a pressure reducing device 18 is provided before the heating device 13 when viewed in the delivery direction. The pressure reducing device is arranged inside the apparatus 1, in particular inside the housing 2 and consists substantially of a pressure reducing valve 19 integrated in the feed line 12.

In this context, the pressure reducing device 18 is designed substantially as an elongated tube, in this context in the direction of the longitudinal extension, which corresponds to the feed direction, having a housing which is divided into two parts, with a first housing part 20 and a second housing part 21.

The two housing parts 20 and 21 may be connected by screwing to each other by means of a thread 22 which extends concentrically with the longitudinal axis x of the device.

Each housing part 20, 21 forms a pipe-like connecting section 23, 24 12 at the free end of each farthest from the thread 22 for the feed line. The tubular feed line 12 preferably aligned in the delivery direction r is preferably pushed onto the ends so that the corresponding connecting sections 23 and 24 seen in the longitudinal direction are inserted in the feed line 12 and at least partly, optionally completely enclosed by the line material.

The housing part 20 furnished with the connecting section has a central inflow channel 25 which open axially outwardly, while the housing part 21 furnished with the connecting section 24 has a corresponding outflow channel 26.

In this context, the outflow channel 26 has a larger diameter than the inflow channel 25. The diameter may be about 1.5 to 2.5 times, further for example about 2 times the size of the diameter of the inflow channel 25.

The channel diameter inside the housing part 21 is selected to be uniform in when viewed in the longitudinal extension of the housing part 21, and further transitions into an expansion section of the housing part 20 with the same diameter.

The transition inside the housing part 20 from the inflow channel 25 with reduced diameter into the expansion section with enlarged diameter is assured by a conically constructed section 28 (see also FIG. 5).

In the channel 29 that is formed as the final result thereof, a plunger 30 with a cylindrical section 31 is arranged, the diameter of which may correspond approximately to 0.75 to 0.9 times, further approximately 0.85 times the size of the free diameter in the area of the outflow channel 26 and the expansion section 27.

The plunger 30 is conformed conically on the end 32 facing towards the feed apparatus r, with a cone angle α, which corresponds to the cone angle of the conical section 28. In this context, a cone angle α from 20 to 40 degrees, for example about 25 degrees may be provided.

The axial length of the conical end 32 is adapted to the axial length of the conical section 28, while the axial length of the cylindrical section 31 corresponds to about ⅔ the axial length of the diameter-enlarged channel section (expansion section 27 and outflow channel 26).

A circular ring space 33 is formed which extends over the entire axial length of the plunger 30 and completely encloses it, through which space the liquid foodstuff is guided to flow around the plunger 30. In this way, a pressure reduction of the transported liquid is achievable, thus for example a pressure reduction from for example 3 bar to 1.5 bar or less. A certain overpressure also still remains in the outflow channel 26 for the purpose of transporting the liquid.

The pressure reduction also proves advantageous with regard to the appearance of the dispensed liquid. In this way, for example less foaming occurs during the dispensing of coffee or other hot drinks.

The plunger 30 may be displaced in the longitudinal direction of the feed line 12 or the channel 29 of the pressure reducing device 18 relative to the wall of the pressure reducing device 18 which surrounds it, in order to adjust the pressure reduction. In this way, the plunger 30 with its conical end 32 may be displaced in the direction opposite the delivery direction r to reduce the dimension of the gap between the conical end 32 and the conical section 28 or in the delivery direction r to increase the dimension of the gap correspondingly. As represented, this may be achieved by the use of an adjusting wheel 34 which is accessible from the outside and attached to the housing part 21, passing through the associated wall with a cylindrical section. The rotation axis y in respect thereof preferably extends perpendicularly to the longitudinal axis x.

Engaging in the channel 29, in particular in the expansion section 27, an eccentrically arranged pin 35 is provided on the part section of the adjusting wheel 34 that passes through the device wall and engaged in a waist-like annular groove 36 in the plunger 30. By turning the adjusting wheel about rotation axis y, the plunger 30 is shifted as whole along the longitudinal axis x via the eccentrically arranged pin 35.

Corresponding to the arrangement of two dispensing nozzles 9 on the apparatus 1, two pressure reducing devices 18 and two heating devices 13 may be provided in the apparatus 1 and in the housing 2. Also correspondingly, two receptacles may also be provided outside of the housing 2 for storing a reserve of the liquids that are to be delivered.

For cleaning or maintenance purposes, for example for setting the pressure reduction by means of the adjusting wheel 34 for example, the pressure reducing device 18 may accessible from one of the side walls 4. For this purpose, as shown in the representation of FIG. 1 a flap 37 may be provided in a side wall 4, which flap allows access to the pressure reducing device 18 after the flap has been pivoted aside or removed.

The preceding notes are intended to explain the totality of the inventions included in the application, each of which also independently develops the state of the art at least by the following feature combinations, wherein two, a plurality of or all of said feature combinations may also be combined, specifically:

An apparatus, which is characterized in that the liquid foodstuff may be discharged from a pressurised receptacle and that a pressure reducing device 18 is arranged before the heating device 13.

An apparatus, which is characterized in that the pressure reducing device 18 consists of a pressure reducing valve 19 integrated in a feed line 12 for the liquid food.

An apparatus, which is characterized in that the pressure reducing valve 19 is embodied as a plunger 30 with a conical end 32 that faces oppositely to the delivery direction r and is inserted in a correspondingly conically shaped section 28 of the feed line 12.

An apparatus, which is characterized in that the plunger 30 is displaceable relative to the feed line 12 in longitudinal direction of the feed line 12 for adjusting the pressure reduction.

An apparatus, which is characterized in that the heating device 13 consists of a section of the feed line 12 which is acted upon by means of a thermal conductor.

An apparatus, which is characterized in that the transfer of heat to the liquid foodstuff takes place as a consequence of a heated solid material 14, in which the thermal conductor is embedded.

An apparatus, which is characterized in that the solid material 14 consists of aluminium and/or preferably that the solid material 14 is heatable by a resistance heater.

An apparatus, which is characterized in that the apparatus 1 has a front face 3 with the dispensing nozzle 9 and two oppositely positioned side walls 4 optionally extending substantially vertically in the operating state, and a rear wall 5.

An apparatus, which is characterized in that the pressure reducing device 18 and the heating device 13 are arranged inside the apparatus 1, whereas the pressurised receptacle 11 is provided outside the apparatus 1.

An apparatus, which is characterized in that the pressure reducing device 18 is accessible from a side wall 4 of the apparatus 1.

All disclosed features are (in and of themselves but also in combination with each other) essential to the invention. The contents of disclosure of the associated/accompanying priority application (duplicate of the preliminary application) are also incorporated in their entirety in the disclosure of this application, also for the purpose of including features of these documents in claims of the present application. With their feature, the subclaims characterize independent inventive refinements of the prior art also without the features of a claim to which they refer, in particular for the purpose of submitting partial applications based on these claims. The invention referred to in each claim may further include one or more of the features from the preceding description, in particular identified with reference numerals and/or listed in the list of reference characters. The invention also relates to design forms in which the features identified in the preceding description are not realised, in particular if they are evidently not essential for the respective intended purpose or can be replaced by other means having technically equivalent effect.

LIST OF REFERENCE CHARACTERS

| | |
|---|---|
| 1 | Apparatus |
| 2 | Housing |
| 3 | Front face |
| 4 | Side wall |
| 5 | Rear wall |
| 6 | Top face |
| 7 | Bottom |
| 8 | Adjustable feet |
| 9 | Dispensing nozzle |
| 10 | Drip tray |
| 11 | Receptacle |
| 12 | Feed line |
| 13 | Heating device |
| 14 | Solid material |
| 15 | Heating element |
| 16 | Electrical connection |
| 17 | Temperature regulator |
| 18 | Pressure reducing device |
| 19 | Pressure reducing valve |
| 20 | Housing part |
| 21 | Housing part |
| 22 | Thread |
| 23 | Temperature regulator |
| 24 | Connecting section |
| 25 | Inflow channel |
| 26 | Outflow channel |
| 27 | Expansion section |
| 28 | Section |
| 29 | Channel |
| 30 | Plunger |
| 31 | Cylindrical section |
| 32 | End |
| 33 | Circular ring space |
| 34 | Adjusting wheel |
| 35 | Pin |
| 36 | Annular groove |
| 37 | Flap |
| r | Delivery direction |
| X | Longitudinal axis |
| y | Rotation axis |
| a | Cone angle |

1. An apparatus for dispensing a heated liquid foodstuff, comprising:
a pressurized receptacle configured to discharge the liquid foodstuff,
a heating device for heating the liquid foodstuff;
a pressure reducing device arranged between the pressurized receptacle and the heating device; and
a dispensing nozzle configured for dispensing the heated liquid foodstuff from the apparatus.

2. The apparatus according to claim 1, wherein the pressure reducing device consists of a pressure reducing valve integrated in a feed line for the liquid foodstuff.

3. The apparatus according to claim 2, wherein the pressure reducing valve is embodied as a plunger with a conical end that faces opposite a delivery direction (r) and is inserted in a correspondingly conically shaped section of the feed line.

4. The apparatus according to claim 3, wherein the plunger is displaceable relative to the feed line in a longitudinal direction of the feed line for adjusting a pressure reduction.

5. The apparatus according to claim 2, wherein the heating device consists of a section of the feed line which is acted upon by a thermal conductor.

6. The apparatus according to claim 5, wherein the thermal conductor is embedded in a heated solid material that transfers heat to the liquid foodstuff to heat the liquid foodstuff.

7. The apparatus according to claim 6, wherein the solid material consists of aluminium and/or is heatable by a resistance heater.

8. The apparatus according to claim 1, wherein the apparatus has a front face with the dispensing nozzle and two oppositely positioned side walls extending substantially vertically in an operating state, and a rear wall.

9. The apparatus according to claim 1, wherein the pressure reducing device and the heating device are arranged inside the apparatus and the pressurized receptacle is provided outside the apparatus.

10. The apparatus according to claim 1, wherein the pressure reducing device is accessible from a side wall of the apparatus.
